(19) United States
(12) Patent Application Publication
(10) Pub. No.: US 2023/0054609 A1
(43) Pub. Date: Feb. 23, 2023

(54) RECURRENT NEURAL NETWORK BASED PREDICTIONS

(71) Applicant: Intuit Inc., Mountain View, CA (US)

(72) Inventors: Yaaqov TAYEB, Tzur Hadasa (IL); Alexander ZICHAREVICH, Petach Tikva (IL); Sigalit BECHLER, Bney-Zion (IL)

(73) Assignee: Intuit Inc., Mountain View, CA (US)

(21) Appl. No.: 17/405,326

(22) Filed: Aug. 18, 2021

(51) Int. Cl. G06Q 40/06; G06N 3/08; G06N 3/04; G06K 9/62

(52) U.S. Cl. CPC G06Q 40/06; G06N 3/08; G06N 3/04; G06K 9/6256

(57) ABSTRACT

Systems and methods for predicting a future status of an entity using a recurrent neural network are described. A system is configured to obtain a first time series data associated with a first entity. The system is also configured to predict, by a recurrent neural network, a future equity status of the first entity based on the time series data. The system is also configured to provide an indication of the future equity status of the first entity, with the future equity status of the first entity to be indicated to a user. An equity status may be a cash status of an entity, and predicting the cash status of the first entity can be based on time series of a plurality of features associated with the first entity provided to the recurrent neural network. The recurrent neural network may be a long short-term memory network.

### TECHNICAL FIELD

This disclosure relates generally to recurrent neural network based prediction systems, such as a recurrent neural network used to detect future events based on existing time series data.

### DESCRIPTION OF RELATED ART

Machine learning models are used in many applications to predict future events. For example, a machine learning model may be used to predict future weather forecasts based on current and historical weather patterns. In another example, a machine learning model may be used to predict future home prices based on current prices and historical economic data. In a further example, a machine learning model may be used to predict cash flow or cash on hand based on current events and historical data to detect whether a company, an organization, or a person is in financial danger in the future (e.g., insolvency or bankruptcy). One category of machine learning models is recurrent neural networks, for which a model's prediction may vary based on a progression through time series data. The recurrent neural network includes a history component for previous data to impact decisions using current data.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter. Moreover, the systems, methods, and devices of this disclosure each have several innovative aspects, no single one of which is solely responsible for the desirable attributes disclosed herein.

One innovative aspect of the subject matter described in this disclosure can be implemented as a method for predicting a future equity status of an entity. The example method includes obtaining a first time series data associated with a first entity. The example method also includes predicting, by a recurrent neural network, a future equity status of the first entity based on the time series data. The example method also includes providing an indication of the future equity status of the first entity. The future equity status of the first entity is to be indicated to a user.

Another innovative aspect of the subject matter described in this disclosure can be implemented in a system for predicting a future equity status of an entity. An example system includes one or more processors and a memory storing instructions that, when executed by the one or more processors, cause the system to perform operations. The operations include obtaining a first time series data associated with a first entity. The example operations also include predicting, by a recurrent neural network, a future equity status of the first entity based on the time series data. The example operations also include providing an indication of the future equity status of the first entity. The future equity status of the first entity is to be indicated to a user.

The recurrent neural network may be a long short-term memory network. To predict the future equity status, the system may obtain time series data for each of one or more features associated with the first entity, and the system may provide the time series data for the one or more features to the recurrent neural network (with predicting the future equity status of the first entity being based on the time series data for the one or more features). The one or more features can include at least one feature specific to the first entity (e.g., a credit rating, number of recurring expenses, changes in income, changes in debt, or number of employees) and can include at least one feature associated with multiple entities including the first entity (such as an industry feature or a location specific feature, including, e.g., number of companies with decreased revenue, number of companies with increased debt, number of employees across an industry, or market capitalization of an industry).

The future equity status may include a future cash status of an entity. For example, a future cash status of an entity may indicate a prediction as to whether: the entity is predicted to be at serious risk of being bankrupt, insolvent, or out of business; the entity is predicted to be in distress with expenses exceeding income; or the entity is predicted to be normal with expenses not exceeding income.

In some implementations, training the recurrent neural network includes, for each entity of one or more entities, obtaining a prior cash availability time series indicating a cash availability to the entity over a previous time period and determining a prior cash status of the entity for one or more points of the prior cash availability time series. Training the recurrent neural network also includes obtaining prior time series data for each of the one or more features associated with the one or more entities. For example, if a change in expenses is one feature used for the first entity to predict a future cash status of the first entity, a prior time series of past changes in expenses for each entity of the one or more entities are obtained. Training the recurrent neural network also includes using the determined prior cash statuses, the prior cash availability time series data, and the prior time series data for each of the one or more features associated with the one or more entities to train the recurrent neural network to generate a cash status of the first entity. Determining a prior cash status of an entity may include: determining that the entity is at serious risk when a financial account for which the prior cash availability time series is associated is closed; determining that the entity is in distress when the entity has more expenses than income from the financial account for a predefined period preceding a point of the prior cash availability time series; and determining that the entity is normal when the financial account remains open and the entity does not have more expenses than income from the financial account for the predefined period preceding the point of the prior cash availability time series.

In some implementations, the system predicts, by the recurrent neural network, that the first entity is to be at serious risk or is to be in distress. In response to predicting that the first entity is to be at serious risk or is to be in distress, the system may adjust at least one time series data for the one or more features associated with the first entity to cause the recurrent neural network to predict that the first entity is normal, and the system may provide an indication of one or more actions to be taken to prevent the first entity from being in serious risk or in distress based on the adjustment to the at least one time series data for the one or more features. The one or more actions may be indicated to the user.

In some implementations, obtaining the first time series data associated with the first entity includes receiving financial records from a financial institution for a linked financial account.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example system to predict a future equity status of an entity, according to some implementations.

FIG. 2 shows an example long short-term memory (LSTM) network to predict a future equity status of an entity, according to some implementations.

FIG. 3 shows an example LSTM layer of the LSTM network in FIG. 2, according to some implementations.

FIG. 4 shows an illustrative flow chart depicting an example operation for predicting a future equity status of an entity, according to some implementations.

FIG. 5 shows an illustrative flow chart depicting an example operation for training a recurrent neural network to predict a future equity status of an entity, according to some implementations.

FIG. 6 shows an illustrative flow chart depicting an example operation for determining one or more actions to be taken to prevent a prediction from the system in FIG. 1, according to some implementations.

Like numbers reference like elements throughout the drawings and specification.

### DETAILED DESCRIPTION

Implementations of the subject matter described in this disclosure may be used to predict a future equity status of an entity. Some aspects of the present disclosure are regarding a recurrent neural network (such as a long short-term memory (LSTM) network) used to predict whether a business is to be in financial distress (such as being in danger of closing, being short of liquidity, or other scenarios) at some point in the future. Some aspects of the present disclosure are also regarding the setup and training of the recurrent neural network (RNN). Some other aspects of the present disclosure are regarding an engine to determine one or more actions to adjust a business feature (such as reducing variable costs, adjusting the number of employees, or obtaining credit to wait through seasonality based factors in the business) to reduce the probability of financial distress after predicting that a business is to be in financial distress. To note, aspects of the present disclosure may also be used for other types of prediction or categorization of an entity (such as a business or individual).

A machine learning model is used in many real world applications to generate predictions of desired information. For example, machine learning models may be used by geological services to predict earthquake locations and timing, may be used by weather forecasting services to predict hurricane trajectories and speeds, may be used by a real estate agent to predict an optimum asking price of a house to be placed on the market, may be used by an insurance actuarial to predict car insurance costs, may be used by a city planner or other municipality entity to predict traffic flow and congestion, and so on. For many entities, a machine learning model may be used to determine whether the entity may be in financial distress in the future or otherwise predict an equity status of the entity for a future point in time.

Various types of machine learning models exist. Machine learning models may be based, e.g., on one or more of decision trees, random forests, logistic regression, nearest neighbors, classification trees, control flow graphs, support vector machines, naïve Bayes, Bayesian Networks, value sets, hidden Markov models, or neural networks configured to generate predictions for the intended purpose. One category of neural networks is recurrent neural networks (RNNs). An RNN uses a history of past data to impact a decision (such as a future prediction) based on current data. In this manner, time series data may be provided to the RNN for the RNN to predict a future point of the time series data or to otherwise make a decision. For example, time series data of a business' expenses and income may be provided to the RNN to predict whether the business is to be in financial distress at some point in the future.

Entities are concerned about their future financial health. However, factors or events may impact an entity's future financial health without being readily apparent at the time of the event or from the factor itself. For example, a small increase in recurring expenses may appear innocuous, but over time, the small increase may cause the entity to incur some financial hardship. Conventionally, an entity's expenses and income may be averaged or reviewed over time to attempt to identify trends that may impact the entity's financial health, but such review is dependent on the subjectivity of the reviewer. In addition, factors outside of the entity's income and expenses (such as industry or local trends) may be indicators of future financial distress, which would not be identified by just observing income and expenses of the entity.

There is recent work in the use of classification and regression trees (CARTs) and the ratios used within the CARTs for bankruptcy modeling (e.g., see Michael Karas and Maria Reznakova's publication titled “Cash Flow Indicators in the Prediction of Financial Distress,” in Kaunas University of Technology's Economics of Engineering Decisions, Vol. 31 No. 5 (2020)). However, such work relies on static ratios and large financial events to specifically detect potential bankruptcy. As a result, if an industry slowly evolves or secondary events occur that impact a business' potential for bankruptcy, use of such CARTs and static ratios do not detect or predict future bankruptcy for the business. In addition, such predictions from the above work cannot be performed at a per financial transaction level. As such, time may be lost between a transaction and when a prediction is made to indicate that a business may become potentially bankrupt. Furthermore, the above work is limited to making a binary prediction about whether or not a business is to go bankrupt. As such, there is no granularity to discern between a business that may be struggling but may not go bankrupt and a business that is financially healthy. In addition, the work only provides a prediction as to a possible bankruptcy with no recommendation being provided to assist in preventing such predicted bankruptcy.

The use of an RNN to predict the financial health of an entity and/or the use of a recommendation engine to determine recommended actions to prevent financial hardship for the entity overcome the above shortcomings of previous efforts. Through the use of an RNN (such as an LSTM network) as described herein, more than a binary choice may be made to indicate the financial health of an entity, gradual changes or secondary factors may be observed over a recent history to predict the entity's financial health, and the RNN may be used at any time to make a prediction, even at real-time or on a per transaction level if desired. The recommendation engine may determine possible changes in one or more factors to improve the financial health of the entity.

Various implementations of the subject matter disclosed herein provide one or more technical solutions to the technical problem of machine learning based predictions. In some implementations, a computing system is configured to obtain a first time series data (such as one or more of a time series of expenses, a time series of income, or a time series of income minus expenses) associated with a first entity. The computing system is also configured to predict (by an RNN) a future equity status of the first entity based on the time series data and provide an indication of the future equity status of the first entity (which is to be indicated to a user). In some implementations, if the computing system predicts that the first entity is to be at serious risk or in distress, the computing system may be configured to adjust time series data for one or more features provided to the RNN to make the prediction in order to cause the RNN to instead predict that the first entity is to be normal (not in risk of financial distress) in the future. Such adjustments to the features may be used to determine and provide an indication of one or more actions to be taken to prevent the first entity from being in serious risk or in distress.

As used herein, an entity may refer to an individual, a business, or any other organization. The examples herein depict small businesses as entities for clarity in explaining aspects of the present disclosure, but any suitable entity may be used. Also as used herein, an equity status may refer to an indication of the financial health of an entity. Example equity statuses may be based on a liquidity, cash on hand, cash flow, or other financial indicators of the entity. The examples herein depict an equity status as a cash status of an entity for clarity in explaining aspects of the present disclosure, but any suitable statuses or measures may be used. As used herein, a cash status refers to the status of cash flow for an entity (such as whether expenses exceed income, income exceeds expenses, or a financial account was severely drawn down and/or closed). In this manner, specific examples herein depict the prediction of a cash flow status of a small business using an RNN (such as an LSTM network), setup and training of the RNN, and the generation of one or more actions for the small business to improve the business' financial health. However, the present disclosure is envisioned to cover other scenarios, including different entities, different equity statuses, different types or setups of RNNs (or other models), and different types of recommendation engines (if included).

Various aspects of the present disclosure provide a unique computing solution to a unique computing problem that did not exist prior to the creation of machine learning models. As such, implementations of the subject matter disclosed herein are not an abstract idea such as organizing human activity or a mental process that can be performed in the human mind. Training a machine learning model (such as an RNN) and using the machine learning model to perform its intended task cannot be performed in the human mind, much less using pen and paper.

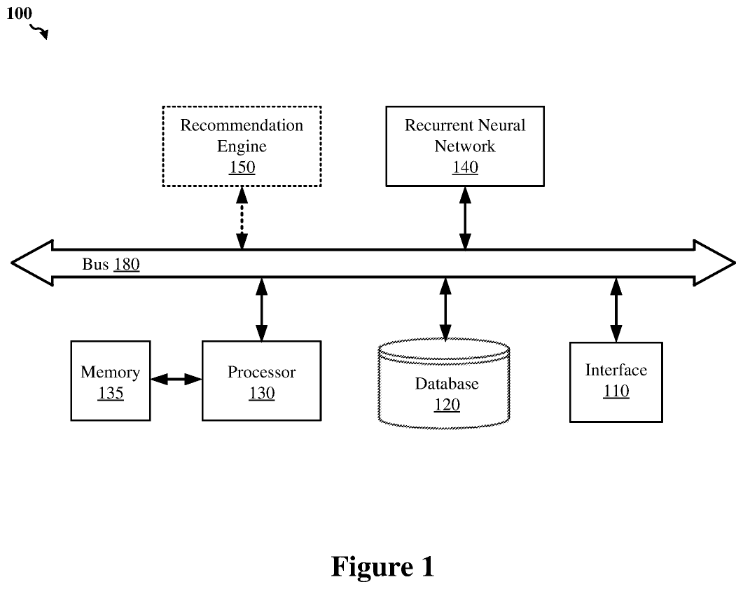

FIG. 1 shows an example system 100 to predict a future equity status of an entity, according to some implementations. For example, the system 100 may be configured to predict a cash status of a small business at some point in the future. The system 100 includes an interface 110, a database 120, a processor 130, a memory 135 coupled to the processor 130, and a recurrent neural network (RNN) 140. The system 100 may also include a recommendation engine 150. In some implementations, the various components of the system 100 may be interconnected by at least a data bus 180, as depicted in the example of FIG. 1. In other implementations, the various components of the system 100 may be interconnected using other suitable signal routing resources.

The interface 110 may be one or more input/output (110) interfaces to obtain time series data associated with a first entity and provide one or more predictions generated by the system 100. The interface 110 may also be configured to provide an indication of one or more actions to be taken to prevent a prediction generated by the system 100. An example interface may include a wired interface or wireless interface to the internet or other means to communicably couple with user devices or other devices. For example, the interface 110 may include an interface with an ethernet cable or a wireless interface to a modem, which is used to communicate with an internet service provider (ISP) directing traffic to and from devices of an entity or other institutions. As used herein, a “user” refers to an entity or an agent of the entity. For example, if the entity is a small business, a user may refer to the business owner, an employee of the business, or another agent of the business (such as the business' accountant).

As noted above, the system 100 is configured to predict an equity status of an entity (such as a business) based on the obtained time series data. As used herein, an equity status refers to an indication of the financial health of the entity. Example indications of financial health may include a liquidity indication, a solvency indication, whether the entity is to file for bankruptcy, amount of cash on hand, or amount of cash flow. In some implementations, an equity status refers to a cash status of an entity. A cash status may refer to cash on hand for the entity over time or a cash flow for the entity over time. A cash flow may refer to income received minus expenses paid.

The time series data to be obtained and used in predicting a future equity status of an entity may include a cash availability time series associated with the entity. For example, a small business owner has a financial account (such as a savings and/or checking account) used for the operation of the business. The cash availability time series may include the amount in the financial account over time. Additionally or alternatively, the cash availability time series may include income over time, expenses over time, income minus expenses over time, a change in income over time, a change in expenses over time, a change in recurring expenses (excluding one-time expenses) over time, or other indicators of the entity's cash availability over time as determined from the financial account. While one financial account is described as being used in the examples for clarity in describing aspects of the present disclosure, any number and types of financial accounts may be used to obtain the cash availability time series associated with the entity. For example, a small business may be associated with a short term credit account, a savings account, a checking account, or other accounts. The system 100 may obtain a cash availability time series by aggregating financial information from the plurality of accounts for the small business.

In some implementations, a user may link one or more financial accounts to the system 100. For example, the user may provide login credentials and other user verification information to allow the system 100 to communicably couple with a financial institution's system to obtain account information for the user. In this manner, the system 100 may obtain cash availability time series information via the interface 110 from one or more financial institution systems. In some other implementations, cash availability time series information may be stored on a user system (such as a business system communicably coupled to the system 100). For example, financial account information may be downloaded nightly to a business' system. In this manner, the system 100 may obtain cash availability time series information via the interface 110 from the entity's system (instead of directly from a financial institution). In the above examples, the system 100 is remote to a user. In some implementations, the system 100 may be local to the user. For example, system 100 may be a local system of the entity. The system 100 may be further configured to perform other operations for the entity (such as being a personal computer for the business to assist with other business operations). In this manner, cash availability information may be obtained by the system 100 from the financial institutions or may be obtained from a local storage or other storage of a local system of the entity.

Predicting a future equity status of an entity may be based on more than a cash availability time series of the entity. For example, while cash on hand or cash flow is important in predicting a future financial health of a business, other features may also be useful in predicting the future financial health of the business. Example features specific to an entity may include a change in sales, a change in revenue from sales, a change in total revenue (which may include more than sales, such as trading of business credits, capital appreciation, investment dividends, or other sources of income), an income to expenses ratio, a total number of recurrent expenses, a percentage of non-recurrent expenses to total expenses, a number of employees (if the entity is a business), a change in income over time, a change in debt over time, or a number of items returned by customers over time (if the entity is a business selling goods).

Features may also include features that are not specific to one entity. In this manner, one or more features may be associated with multiple entities including the first entity. For example, a business may be associated with a specific industry including the multiple entities (e.g., a copper producer may be associated with a metals industry, a movie theatre may be associated with a movie theatre industry or entertainment industry, etc.). In this manner, one or more features may be industry features. Example industry features may include trends in industry revenue, trends in industry sales, trends in number of employees in the industry, or trends in seasonality of the industry (such as whether the industry cyclically contracts or expands at specific points in the year). In addition or alternative to the multiple entities being joined by industry, the multiple entities may be joined by location. For example, the multiple entities may be in the same town or other geographic location. In this manner, one or more features may be location specific features. Example location specific features may include trends in revenue in the location, trends in employment in the location, trends in home prices or other equity measurements in the location, trends in location growth, or trends in location seasonality (e.g., seasonality in revenue based on the location being a tourist location, such as a beach resort or skiing resort). A trend may refer to an absolute number for a feature (such as a trend in revenue referring to a total amount of revenue) or a change in the feature over time (such as a trend in revenue referring to a change in revenue between a previous day and the current day).

As noted above, the cash availability time series data may be obtained via the interface 110 from a user system (if the system 100 is a remote system), a storage (if the system 100 is a local system), or via the interface 110 from a financial institution system. Time series data of the one or more features (such as the example features depicted above) may be obtained from a user system for features specific to the entity or another system for features associated with multiple entities including the entity. For example, a town's chamber of commerce may include a system with publicly available data regarding the town's businesses. In another example, an industry may be associated with a consortium having a system with publicly available data regarding the industry. The system 100 may obtain the time series data for the one or more features via the interface 110 from such systems.

The obtained time series data associated with an entity may be provided to the RNN 140 to generate one or more predictions regarding the financial health of the entity. If the system 100 includes the recommendation engine 150, the time series data associated with the entity may also be provided to the recommendation engine 150 to determine one or more actions to be taken to prevent a prediction by the RNN 140 from occurring. In some implementations, the information obtained from another system (such as from an investment firm) may not be in a format to be used by the RNN 140. For example, an investment firm may provide the transactions for a checking account for the last 90 days, but a feature to be provided to the RNN 140 may be daily income minus expenses. The system 100 may be configured to reformat the information into the time series data to be ingested by the RNN 140. Generating the predictions and optionally determining the one or more actions are described in more detail below.

As noted above, the interface 110 may also be configured to provide an indication of one or more predictions of an equity status of an entity and, in some implementations, provide an indication of one or more actions to be taken for the entity to prevent a prediction from occurring. If the system 100 is remote to a user (such as the system 100 being part of an online service provided to the entity), the system 100 may provide the indications via the internet to the user. If the system 100 is local to the user (such as the system 100 being a personal computer or other system in a business), the interface 110 may include a display, a speaker, a mouse, a keyboard, or other suitable input or output elements that allow interfacing with the user to provide the one or more indications to the user.

The database 120 may store the time series data (such as the cash availability time series and the time series data for the one or more features). The database 120 may also store one or more predictions generated using the RNN 140, an indication of one or more actions determined by the recommendation engine 150, one or more applications to be executed by the system 100, or one or more configurations for the RNN 140 (such as one or more variables to train the RNN 140). If the database 120 is a remote system configured to predict an equity status for various entities (such as a first entity, a second entity, and so on), the database 120 may store predictions and optionally an indication of one or more actions for each entity. In some implementations, the database 120 may include a relational database capable of presenting information as data sets in tabular form and capable of manipulating the data sets using relational operators. The database 120 may use Structured Query Language (SQL) for querying and maintaining the database 120. While the examples herein depict operations to be performed by the system 100 with reference to a first entity for clarity purposes, the system 100 may be configured to perform operations associated with any number of entities (such as generating predictions for a plurality of entities).

The processor 130 may include one or more suitable processors capable of executing scripts or instructions of one or more software programs stored in system 100 (such as within the memory 135). For example, the processor 130 may be capable of executing one or more applications, the RNN 140, or the recommendation engine 150. The processor 130 may include a general purpose single-chip or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. In one or more implementations, the processors 130 may include a combination of computing devices (such as a combination of a DSP and a microprocessor, a plurality of microprocessors, one or more microprocessors in conjunction with a DSP core, or any other such configuration).

The memory 135, which may be any suitable persistent memory (such as non-volatile memory or non-transitory memory) may store any number of software programs, executable instructions, machine code, algorithms, and the like that can be executed by the processor 130 to perform one or more corresponding operations or functions. For example, the memory 135 may store the one or more applications, the RNN 140, or the recommendation engine 150 that may be executed by the processor 130. The memory 135 may also store the obtained time series data and/or an indication of the predictions generated or actions determined. In some implementations, hardwired circuitry may be used in place of, or in combination with, software instructions to implement aspects of the disclosure. As such, implementations of the subject matter disclosed herein are not limited to any specific combination of hardware circuitry and/or software.

The RNN 140 may be configured to predict a future equity status of a first entity based on the obtained time series data. The system 100 obtains the time series data and provides the time series data to the RNN 140. In this manner, a plurality of time series, including a cash availability time series associated with a financial account and a time series associated with each of one or more features (such as total items sold, daily revenue, a trend in industry employment, etc.). The RNN 140 may then generate a prediction as to a future equity status of the first entity. In general, the RNN 140 uses an influence of prior information to generate a prediction based on current information. For example, instead of a purely feed forward neural network, an RNN may include a feedback loop between nodes or layers or other means for prior outputs of a node or layer to impact a current output of a node or layer. The RNN 140 is an artificial neural network including a plurality of nodes configured for obtaining prior outputs of nodes (such as gated recurrent units (GRUs) or LSTMs). The plurality of nodes are connected to form a directed graph along a temporal sequence. In some implementations, the RNN 140 includes a long short-term memory (LSTM) network.

Any suitable type of prediction of a future equity status of an entity may be generated by the RNN 140. In some implementations, an example prediction is a value along a scale indicating a future equity status of the first entity. For example, the RNN 140 may be configured to generate a value from 0 to 1 (or 0 to 100), with 0 indicating that the first entity is in poor financial health and 1 (or 100) indicating that the first entity is in good financial health. In some implementations, the RNN 140 may be configured to categorize the first entity in generating a prediction. For example, an example prediction is a label of the future equity status of the first entity, with the label associated with a category to which the first entity is categorized. For example, two or more bins (e.g., three bins) may be associated with labels. Using the previous example of a value on a scale from 0 to 1 generated by the RNN 140, a first bin may include values from 0 to a first threshold and be associated with a label of an entity “at serious risk,” a second bin may include values from the first threshold to a second threshold and be associated with a label of an entity “in distress,” and a third bin may include values from the second threshold to 1 and be associated with a label of an entity as “normal” (i.e., not in distress or at serious risk).

While binning is described in the above example for categorization, the RNN 140 may use any suitable manner to categorize an entity into one of two or more categories. While three different categories/labels are described in the below examples, any number of categories or labels may be used. For example, the RNN 140 may be configured to categorize an entity between two categories, such as normal and in distress (with the category of at serious risk from the previous example being included in the category of in distress). In another example, the RNN 140 may be configured to categorize an entity between four or more categories. In this manner, the granularity as to which the RNN 140 categorizes a first entity to predict a future equity status of the first entity is adjustable. An example RNN, operations of the RNN, and labels of an entity are described below. While the examples of an RNN are regarding an LSTM network, any suitable type of node or unit may be used for the RNN, such as a GRU.

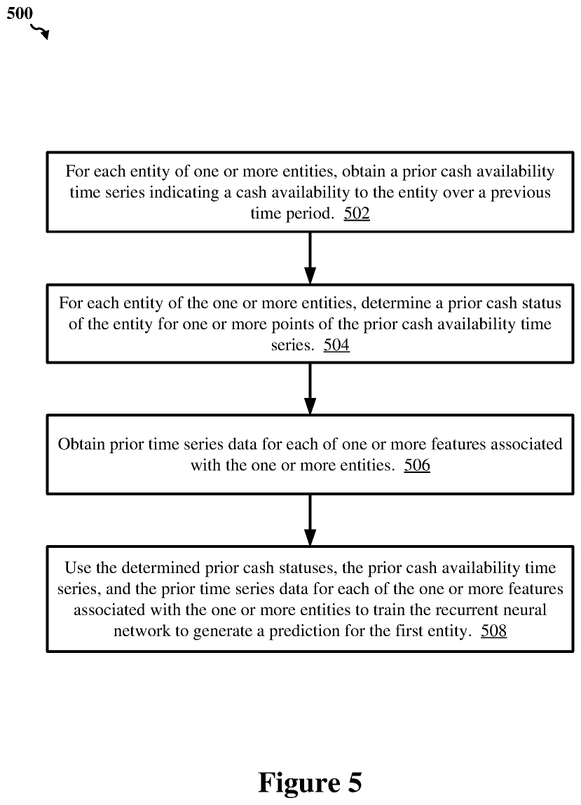

The RNN 140 is to be trained before use (or retrained during use) in predicting a future equity status of a first entity. In some implementations, training is based on previous time series data for one or more entities and labels/categorizations of the one or more entities for the previous time series data. For the previous time series data for an entity and the labels/categories determined, a data point from the time series data (the input to the RNN) and an associated label for the data point (the desired output of the RNN) may be used as a tuple in training the RNN 140. Multiple tuples may be used in training the RNN 140 via supervised learning. In this manner, the RNN 140 is trained to predict a determined label for an entity (the desired output) based on the associated time series data as the input. A difference in the actual output of the determined label and the desired output of the desired label may be used as feedback in training the RNN 140. Training the RNN 140 is described in more detail below with reference to FIG. 5.

In some implementations, in addition to the system 100 being configured to generate a prediction of a future equity status of an entity (such as by the RNN 140), the system 100 may be configured to determine one or more actions to be performed to prevent a prediction from coming true. The recommendation engine 150 is configured to determine the one or more actions to be performed, which may be indicated to a user in order for the user to take action and prevent a prediction from occurring. For example, the RNN 140 may predict that a small business is to be in distress some time in the future based on the time series data. The system 100 may provide the time series data to the recommendation engine 150, and the recommendation engine 150 may be configured to adjust the time series data to determine an adjusted time series data that does not cause the RNN 140 to predict that the business is to be in distress. As noted above, the time series data includes a time series data for one or more features. Adjusting the time series may include adjusting the data points of at least one time series data for the one or more features. Some of the entity specific features (such as revenue, recurring expenses, one-time expenses, employment, revenue of specific goods sold, and so on) are within the control of the entity. For example, increasing sales may increase expenses without sufficient revenue increase to compensate for the increase in sales (such as extended store hours or additional distribution channels increasing expenses greater than the increased revenue realized from such). As such, adjusting the time series data of features regarding, e.g., expenses associated with distribution, store hours, and so on may indicate if actions to adjust such features may be beneficial to prevent a business from being in distress or at serious risk. For example, based on the adjustments to the time series data, the recommendation engine 150 may determine that a store should be open on specific high traffic days during which the store is typically closed, should be closed on specific low traffic days, should be closed at specific hours, should cater to carrying specific products with more demand or higher profit margins, etc.

Some features may be out of the entity's control (such as features regarding fixed costs, industry features, or location specific features). For example, a small size copper producer may not have control over an example industry feature of total revenue for the entire metal production industry. The recommendation engine 150 may be configured to adjust only the time series data associated with features in the entity's control since actions to be recommended would be based on such actions impacting the features whose time series data are adjusted by the recommendation engine 150. Regarding the previous example of an industry feature of total revenue for the entire metal production industry, the recommendation engine 150 is prevented from adjusting the time series data of the industry feature for the small size copper producer.

In some implementations, the system 100 includes an indication as to which features' time series data may be adjusted. For example, 50 features may be predefined, and the system 100 is configured to obtain time series data for each of the 50 features. 40 features' time series data may be adjustable based on actions by the entity. The database 120 may store the time series data for each feature for a first entity. The database 120 may also include a flag for each feature to indicate whether or not the associated time series data may be adjusted by the recommendation engine 150. The flags may be previously determined manually. The recommendation engine 150 may prevent adjusting a time series based on an associated flag for the time series.

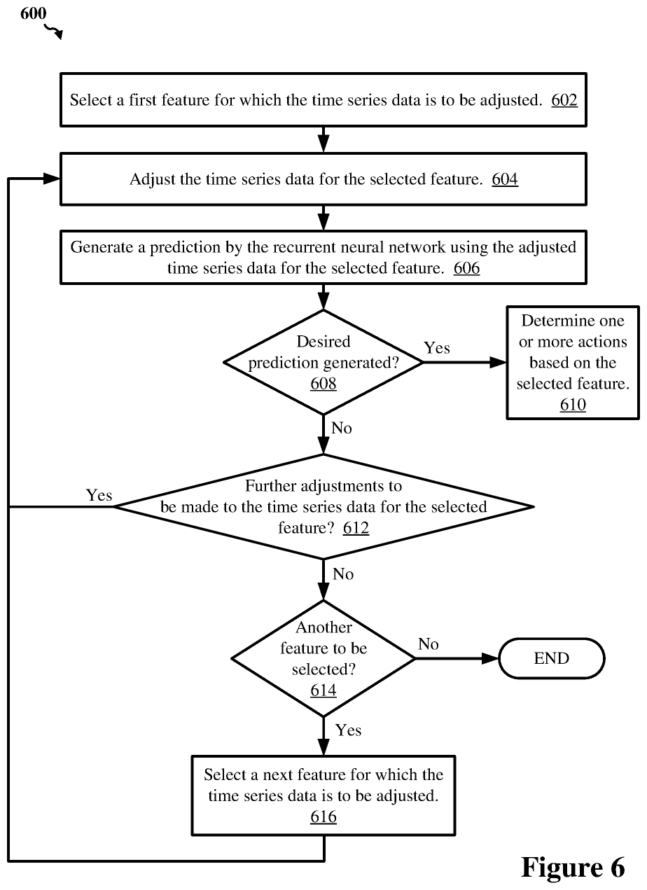

In some implementations, the system 100 may be configured to have the recommendation engine 150 recursively adjust times series data for one or more features, with the RNN 140 generating a new prediction based on the adjusted time series data for each recursion. For example, time series data of a feature may be iteratively adjusted and a prediction generated over multiple times until the prediction indicates that the future cash status of a business is predicted to be normal. Based on the changes to the time series data to cause the new prediction, the system 100 may determine the one or more actions to be performed to prevent the original prediction. Determining the one or more actions, including recursively adjusting the time series data and generating new predictions, are described below with reference to FIG. 6.

While the RNN 140 and the recommendation engine 150 are depicted as separate components of the system 100 in FIG. 1, the components 140 and 150 may be a single component, may include additional components, may include software including instructions stored in memory 135 or the database 120, may include application specific hardware (e.g., one or more ASICs), or a combination of the above. As such, the particular architecture of the system 100 shown in FIG. 1 is but one example of a variety of different architectures within which aspects of the present disclosure may be implemented. For example, in other implementations, components of the system 100 may be distributed across multiple devices, may be included in fewer components, and so on. While the below examples are described with reference to system 100, any suitable system may be used to perform the operations described herein.

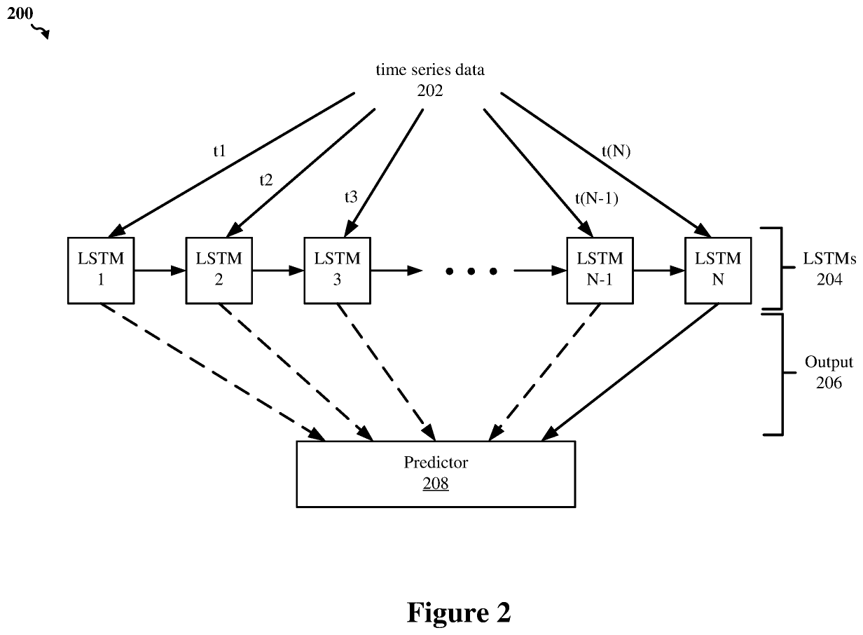

Referring back to the RNN 140, the RNN 140 may be an LSTM network. In some implementations, the LSTM network may include an LSTM unit with a feedback from the output of the LSTM unit to the input of the LSTM unit. In this manner, the next output from the LSTM unit is impacted by the previous output of the LSTM unit. An LSTM network with one or more feedback loops may be logically viewed as a directed graph of LSTM units in a feed forward manner (such as depicted in FIG. 2). However, the RNN 140 may be any suitable LSTM network with any suitable arrangement of LSTM units, including number of LSTM units, number of layers of LSTM units, the connections between units or layers, and so on.

FIG. 2 shows an example LSTM network 200 to predict a future equity status of an entity, according to some implementations. The LSTM network 200 includes LSTMs 204 and a predictor 208. The LSTMs 204 obtain time series data 202 and generate an output 206 to be provided to the predictor 208. The predictor 208 generates the prediction of a future equity status for a first entity based on the output 206.

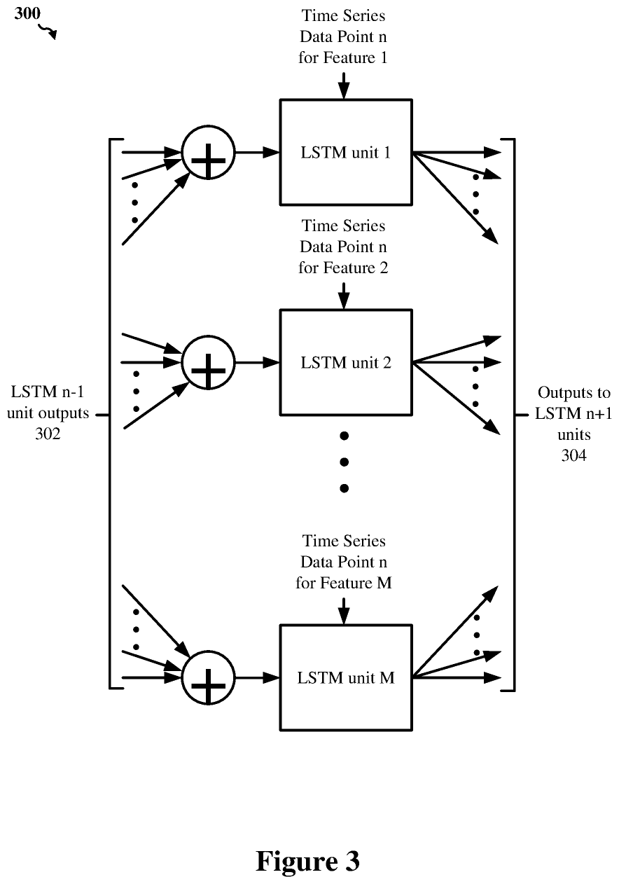

The LSTMs 204 include LSTM 1, LSTM 2, LSTM 3, and so on to LSTM N (i.e., LSTM n for integer n from 1 to N). The LSTMs may refer to layers of LSTM units. In this manner, each LSTM n is an LSTM layer of one or more LSTM units. In some implementations, each feature is associated with an LSTM unit of LSTM n. Each unit of LSTM n may be connected to one or more units of LSTM n+1 and LSTM n−1. Each layer of the LSTMs 204 is configured to receive data points of a point in time of the time series data. In this manner, each LSTM unit of the layer may receive a data point for an associated feature (which is described in more detail below with reference to FIG. 3). For LSTM layers after the first LSTM layer, the LSTM layer is also configured to receive outputs from the previous LSTM layer.

In some implementations, the time series data may include daily data points. For example, the system 100 may obtain transaction records for a financial account (such as from a financial institution or from locally stored records for the financial account). The system 100 may then determine a data point for the day. An example daily data point from the financial records may include daily income minus daily expenses, account balance, daily change in the account balance, daily change in expenses, or other suitable data points of a cash availability time series. The system 100 may also obtain daily data points for other features, such as daily number of sales, change in daily sales, daily revenue, change in daily revenue, number of employees, daily industry data points, daily data points for businesses of a same location, etc. as described above with reference to one or more features associated with the business. Any number of features M (for integer M greater than or equal to one) may be used by the system 100.

The number of data points of a time series to be provided to the LSTM network 200 may equal the number of LSTM layers of the LSTM network 200. For example, if N equals 90, 90 daily data points of time series data may be provided to the LSTM network 200. The system 100 may generate a prediction associated with day 0 (which is associated with data point t(N)). In this manner, LSTM N receives data point t(N), LSTM N−1 receives data point t(N−1), and so on with LSTM 3 receiving t3, LSTM 2 receiving t2, and LSTM 1 receiving t1. With N equal to 90, 90 days of the previous daily data points (0 to t90) are provided to the LSTM network 200 to predict an equity status of the entity for day 0. To note, any day may be selected for which to generate an equity status prediction. For example, each night, the system 100 may generate a prediction based on the current daily data point. In another example, the system 100 may generate a prediction for various data points (such as randomly, at a specified interval, or in another suitable manner).

Multiple data points may be provided to an LSTM layer of the LSTM network 200. For example, one or more features associated with the entity may include a plurality of features. Each feature is associated with time series data. In this manner, a data point of the time series data for each feature may be provided to an LSTM layer of the LSTM network 200. In a simplified example, if the one or more features are three features, three data points (one for each feature) may be provided to each LSTM layer. If N is 90, 90 data points for each feature are provided across the LSTM layers of the LSTM network 200. An example of how the data points are provided to the LSTM layers are described below with reference to FIG. 3.

FIG. 3 shows an example LSTM layer n 300 of the LSTM network 200 in FIG. 2, according to some implementations. In the example, 1<n<N, with outputs from LSTM layer n−1 provided to the LSTM layer n 300, and outputs by the LSTM layer n 300 provided to LSTM layer n+1. The LSTM layer n 300 includes M LSTM units for integer M greater than or equal to 1. In the example, M equals the number of features for which time series data is provided to the LSTM network 200. In this manner for LSTM layer n 300, data point n for feature 1 is provided to LSTM unit 1, data point n for feature 2 is provided to LSTM unit 2, and so on until data point n for feature M is provided to LSTM unit M. An output 304 of an LSTM unit m (for integer m greater than or equal to 1 and less than or equal to M) is based on previous output 302 from LSTM layer n−1 and the obtained data point for feature m. To note, one of the features may be a cash availability associated with a cash availability time series.

In the example layer depicted, the outputs of the multiple units from the previous layer n−1 may be combined in some manner to generate the input to each LSTM unit of layer n. Training the LSTM network 200 may include determining how to combine the multiple outputs from the previous layer to generate the input to the current layer (such as weighting the inputs or disregarding one or more inputs). In some other implementations, the input to LSTM unit m of layer n may be the output of LSTM unit m of layer n−1. In such an implementation, the LSTM network may be conceptualized as separate LSTM chains, with each chain corresponding to a specific feature of the entity. While not shown, the outputs of the LSTM units of LSTM layer N (the last LSTM layer) may be combined in some manner to generate a single value. In some other implementations, the separate values from the multiple LSTM units of LSTM layer N may be output.

Referring back to FIG. 2, the output 206 of LSTM N (which may be one or more values) is provided to the predictor 208 to predict an equity status of the entity. In some other implementations, the outputs of the previous LSTM layers (depicted as dashed lines in FIG. 2) may also be provided to the predictor 208 to be used in predicting an equity status of the entity. If the output 206 is a single value (such as a vector or scalar), the predictor 208 may use one or more thresholds to predict an equity status. For example, if the categories or labels to indicate the equity status of an entity are “serious risk,” “in distress,” and “normal,” two thresholds may be used to categorize an output 206 into one of the three categories: a first threshold to differentiate between “serious risk” and “in distress” and a second threshold to differentiate between “in distress” and “normal.” The thresholds may be determined during training of the LSTM network 200. If the output 206 includes a plurality of values provided to the predictor 208, the predictor 208 may use a grouping algorithm or any other suitable manner to generate a label/prediction based on the output 206.

While LSTM network 200 is depicted as multiple LSTM layers, in some implementations, the LSTM network may be a single LSTM layer with a feedback loop. For example, referring back to FIG. 3, the output 304 may be fed back as input 302 for the LSTM units. In this manner, the same LSTM units are used to generate outputs for LSTM 1, LSTM 2, and so on to LSTM N. As such, FIG. 2 may be an example physical implementation of the LSTM network or may be a conceptualization of the LSTM network. Any suitable LSTM network or other RNN may be used, and the present disclosure is not limited to the example implementation depicted in FIGS. 2 and 3.

Example operation of the system 100 and LSTM network 200 in explaining aspects of the present disclosure are described below. For example, the LSTM network 200 may be used to predict a future equity status, and the recommendation engine 150 may be used to determine one or more actions to be performed to prevent a prediction from occurring. The below examples of generating a prediction and determining one or more actions are with reference to a business as a first entity, a user as the owner of the business, daily data points as periodic data points of time series data, and specific examples of features associated with the first entity for clarity in explaining aspects of the present disclosure. As noted above, aspects of the present disclosure may be directed to other types of entities, other types of users, other periods or types of periodic data (such as weekly, hourly, etc.), or other features.

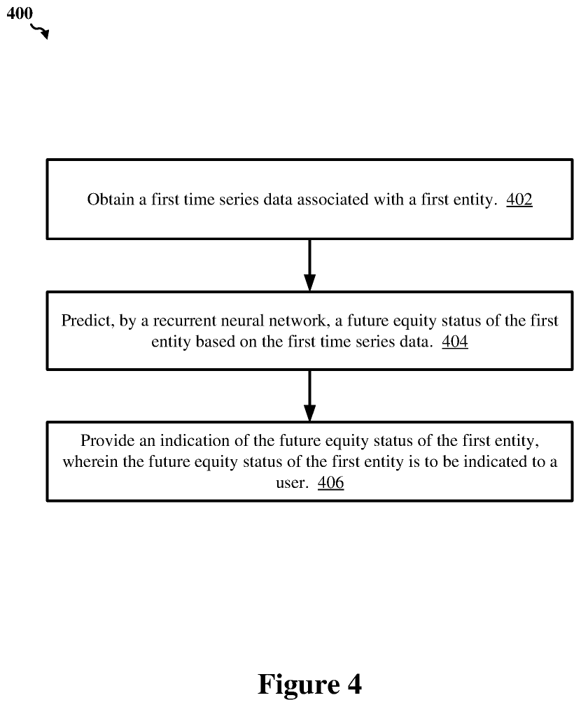

FIG. 4 shows an illustrative flow chart depicting an example operation 400 for predicting a future equity status of a first entity, according to some implementations. For example, an RNN 140 (such as the LSTM network 200) may be trained to predict a future equity status of one or more entities (such as the first entity). At 402, the system 100 obtains a first time series data associated with a first entity. The first time series data is to be provided to the RNN 140 (such as the LSTM network 200) for the RNN 140 to generate a prediction of the future equity status of the first entity.

In some implementations, the future equity status of the first entity includes a future cash status (such as cash availability or cash flow) of the first entity. In this manner, the first time series data may include a cash availability time series indicating a cash availability to the first entity over a time period. The cash availability may be based on a financial account for the entity. For example, information from a business bank account (such as a savings or checking account) may be used to determine the cash availability time series.

In obtaining the first time series data, a financial account at a financial institution may be linked to the system 100. In this manner, the system 100 may use user login credentials to access the entity's financial account on a financial institution's system (such as via an online portal). The system 100 may then obtain transaction information or other information regarding the financial account. In a specific example, the system 100 may access the financial institution's system and obtain information for the financial account each night to generate daily data points of time series data. However, any suitable time period may be used, such as hourly or weekly, or access may be on demand. For example, if the system 100 obtains a request from a user to generate a prediction, the system 100 may access the financial institution's system and obtain the information regarding the financial account in response to the request. In some other implementations, the financial data may be stored locally. For example, a user may gather the financial information from the financial institution on his own, and the financial information may be provided to the system 100 by the user. In this manner, the system 100 may not access a financial institution's system directly.

The financial information, whether obtained directly from a financial institution system or from a user, may not be in a suitable format for the RNN 140. For example, the financial information may include transactions (including income and expenses) that occurred, but the transactions are not in a cash availability time series format. For example, a cash availability time series may be a time series of daily data points indicating a difference between income and expenses to and from the financial account. Alternatively, the cash availability time series may indicate a trend in daily income minus expenses (such as a rate of change between days) or other indicator of a cash availability to the first entity over a time period. In another example, transaction information may be obtained from multiple financial accounts for the entity (such as different accounts from the same institution or accounts from different institutions). The system 100 may combine information from multiple accounts to generate a first time series data. As such, obtaining the first time series data (402) may include the system 100 formatting received information associated with the financial account to generate the first time series data.

Any suitable time period may be used for obtaining the first time series data. For example, the past 90 days of daily data points may be obtained to provide to the RNN 140. The time period may be adjusted to balance processing time and resources against the accuracy of the predictions of the RNN 140. For example, longer time periods require more time series data to be obtained, a more complicated RNN 140, and more time and resources to generate a prediction, while shorter time periods may reduce the accuracy of predictions by the RNN 140. If the RNN 140 includes LSTM network 200, a time period of 90 days of daily data points corresponds to N equal to 90. In some implementations, the system 100 may obtain additional time series data (such as a year's worth of data) but may provide only a portion of the data to the RNN 140 (such as 90 days' worth of data from the year's worth of data that is obtained).

A cash availability time series from one or more financial accounts is but one example time series of data points that may be provided to the RNN 140. In addition, time series data associated with one or more features may also be provided to the RNN 140 (such as the LSTM network 200) to predict the future equity status of the first entity. In this manner, the system 100 may obtain time series data for each of one or more features associated with the first entity. For example, if 10 features are associated with the first entity, the first time series data may include 10 time series of data points (one time series for each feature). The system 100 may be configured to use any number of features and any specific features to generate a prediction. In some implementations, the number of features and specific features to be used are preselected based on time and processing resources required to generate a prediction. For example, as more features are added, more time series data is required to be gathered, the complexity of the LSTM network increases, and the amount of time required to generate a prediction increases. Which features are to be used may be based on a balance between accuracy of the predictions and the time and resources required to generate the predictions.

As noted above, the one or more features may include at least one feature specific to the first entity. Example daily data points of time series data for entity specific features may include daily revenue of the first entity, daily sales amount of the first entity, daily number of sales of the first entity, daily number of store customers for the first entity, a trend in daily numbers (such as a rate of change between days), and so on. Additionally or alternatively, the one or more features may include at least one feature associated with multiple entities including the first entity. For example, a feature may be an industry specific feature or a location specific feature regarding multiple entities (such as multiple businesses). Any other suitable example features may be used by the system 100 to predict a future equity status (such as a future cash status) of the first entity. The data points of the time series data for the one or more features may be obtained from any suitable source, such as a chamber of commerce system or website, an industry consortium's system or website, a third party data aggregator, and so on. In some implementations, the user may obtain the time series data for the one or more features and provide the time series data to the system 100. Similar to obtaining the first time series data, obtaining the time series data for the one or more features may include the system 100 formatting received information associated with the one or more features to generate the time series data. In some implementations, the first time series data is associated with a feature of the one or more features (such as a cash availability being a feature).

At 404, the system 100 predicts (by the RNN 140) a future equity status of the first entity based on the first time series data. For example, if the RNN 140 includes the LSTM network 200, the system 100 provides the first time series data to the LSTM network 200. If N equals 90, the system 100 obtains at least 90 data points of the first time series data (up to the current data point). The current data point is t(N), the immediately preceding data point is t(N−1), and so on. In this manner, LSTM 1 generates its output based on t1, LSTM 2 generates its output based on t2 and the output from LSTM 1, LSTM 3 generates its output based on t3 and the output LSTM 2, and so on to LSTM N generating its output based on t(N) and the output from LSTM N−1. As noted above, t(n) may be one or more data points specific to a point in time (such as a specific day). The number of data points may equal 1 (for the first time series data point, such as a cash availability time series data point) plus the number of features to be used by the system (with one data point for each of the features). If the cash availability time series is the only time series data to be used, t(n) includes one data point. However, t(n) may include any number of data points depending on the number of features to be used.

The output 206 of the LSTMs 204 is provided to the predictor 208 to predict a future equity status of the first entity. If time series data for one or more features is provided to the LSTMs 204, the output 206 is based on the time series data for the one or more features. In this manner, the prediction by the predictor 208 is based on the time series data for the one or more features. As noted above, the predictor 208 may be any suitable means to generate a prediction based on the output 206. For example, if the predictor 208 is to categorize a first entity into two or more categories regarding a cash status of the first entity, one or more thresholds may be compared to the output 206 to categorize the first entity into one of the two or more categories. In some implementations, the predictor 208 categorizes the first entity into one of three categories (such as “at serious risk,” “in distress,” and “normal”). Example definitions of each of the three categories of a cash status of an entity are:
“at serious risk”: a financial account for which the cash availability time series is associated is closed. For example, if a savings account at a financial institution that is used in generating the cash availability time series data is closed, the entity may be determined to be at serious risk. The savings account may be the primary account or another account indicating that a business may go out of business or that the entity may be insolvent or declare bankruptcy. In another example, the financial account may be from a provider that also provides the system 100 (such as a financial accounting or bookkeeping firm that provides a short term bridge account from a typical savings or checking account for day to day business activities).
“in distress”: the financial account remains open, but the entity has more expenses than income from the financial account for a predefined period preceding a point of the cash availability time series. For example, if N equals 90 for daily data points for the LSTM network 200, an entity may be in distress at day 0 if expenses are greater than income over the last 90 days (day −89 to day 0). The entity is considered to be in better financial health than being “at serious risk,” but the entity is not considered to be in good financial health or otherwise normal.
“normal”: the financial account remains open and the entity does not have more expenses than income from the financial account for the predefined period preceding the point of the cash availability time series. For example, if N equals 90 for daily data points for the LSTM network 200, an entity may be labeled normal at day 0 if expenses are less than income over the last 90 days (day −89 to day 0).

While three example categories are described, any number of categories greater than one may be used. In traditional bankruptcy forecasting, a forecast may be a binary choice between whether a business is to enter bankruptcy or not. However, a business may not be in good financial health but not be bankrupt (such as being “in distress”). By using more than two categories to predict an equity status of an entity, the system 100 is able to indicate varying degrees of financial health of an entity. As such, different actions can be taken by a user or entity based on the categorization. For example, a prediction of “at serious risk” may require more drastic action to be taken to save a business (such as significantly reducing costs that may impact long term growth of the company) than for a prediction of “in distress” (which may require more moderate actions). Therefore, additional granularity in indicating a future equity status of an entity may assist in a user understanding the financial health of the entity in greater detail than a binary indication about whether the entity may go bankrupt.

At 406, the system 100 provides an indication of the future equity status of the first entity (with the future equity status to be indicated to the user). For example, if the system 100 is remote to the user, the system 100 may indicate the prediction of “at serious risk,” “in distress,” or “normal” via the interface 110 and through the internet to the user's system (such as a personal computer or smartphone accessing the system 100). The user's system may then provide the indication to the user. If the system 100 is local (such as being included in the user's personal computer), the system 100 may indicate the prediction to the user via the display or other means. As noted above, any type of indication or prediction may be provided. For example, instead of a label as described above, the indication may be a score (such as from 0 to 100) indicating the financial health of the entity, and the score may be indicated to the user.

Before the RNN 140 may accurately predict an equity status of an entity, the RNN 140 is to be trained using historical time series data. For example, for the LSTM network 200, one or more of the weights of each LSTM unit is to be determined, the weights of the outputs as inputs between LSTM layers may be determined, the weights of outputs of multiple LSTM units from a previous layer to be combined as an input to a current layer's LSTM unit may be determined, the weights of the output 206 from the LSTMs 204 to be used in generating the prediction by the predictor 208 may be determined, or the thresholds used by the predictor 208 to categorize the entity based on the output 206 may be determined. Training the RNN 140 may be via supervised learning, such as described below with reference to FIG. 5.

FIG. 5 shows an illustrative flow chart depicting an example operation 500 for training an RNN 140 to predict a future equity status of an entity, according to some implementations. In the examples below, the RNN 140 is described as the LSTM network 200 for clarity in describing aspects of the disclosure. However, any suitable RNN (or another suitable sequential model) may be used by the system 100. Training the RNN 140 is based on historical time series data, which may be from one entity or from a plurality of entities. In a simplified example, historical time series data of the first entity is exclusively used to train the RNN 140. In this manner, historical time series data for a business may be used to train the RNN 140 to determine a future equity status of that business. In a different example, the system 100 may have historical time series data for a plurality of entities. Increasing the size of training data may allow the RNN 140 to be trained to provide more accurate predictions. In this manner, time series data for a plurality of entities may be used to train the RNN 140 to predict a future equity status of a first entity. The first entity may or may not be included in the plurality of entities. In some implementations, the plurality of entities are limited to entities similar to the first entity. For example, which other business time series data is to be used may be limited to businesses of the same size, the same industry, a similar location, or other factors associated with a first business for which the RNN 140 is to be trained to predict its future equity status. In this manner, historical time series data for a Fortune 500 company may not be used to train the RNN 140 for a small business or sole proprietorship. S coping the size of the training data (such as which entities, the age of the historical time series data, and so on) may be performed in any suitable manner.

At 502, for each entity of one or more entities, the system 100 obtains a prior cash availability time series indicating a cash availability to the entity over a previous time period. As noted above, the one or more entities may be one entity. If the one entity is the first entity (for which a prediction is to be made), the system 100 obtains the cash availability time series over a previous time period for the first entity. The previous time period may be any suitable time period, such as the past 6 months, one year, two years, etc. If the data points are daily for the time series, the system 100 may obtain daily data points over the defined time period. In some implementations, the system 100 may obtain the information from the financial institution providing the financial account to the first entity. In some other implementations, the system 100 may store the information regarding the financial account. For example, the user may previously obtain the information, which is provided to the system 100 by the user. In another example, the information may have been previously collected over time by the system 100, and the information is stored on the system 100 (such as by the database 120 or by the memory 135). The information may be formatted by the system 100 to be a cash availability time series ingestible by the RNN 140. Alternative to the entity being the first entity, the entity may be a different entity. In this manner, historical time series data (such as a previous cash availability time series) of a second entity may be used to train the RNN 140 for the first entity.

Alternatively, the one or more entities may be a plurality of entities. In this manner, the system 100 obtains a prior cash availability times series for a plurality of entities. In some implementations, the system 100 may have stored prior time series data for the plurality of entities. For example, historical financial information for a plurality of companies may be publicly available or may be provided with agreement to its use by the plurality of companies, and the historical financial information is provided to the system 100 for later use. The information may be formatted by the system 100 to be a cash availability time series for each of the entities, with each cash availability time series being ingestible by the RNN 140.

At 504, for each of the one or more entities, the system 100 determines a prior cash status of the entity for one or more points of the prior cash availability time series. If the system 100 is to predict a future equity status of a first entity as one of “at serious risk,” “in distress,” or “normal” (as defined above) and assuming that the one or more entities is exclusively the first entity and the previous time period is the last two years for simplicity, the system 100 obtains the last two years of daily data points of a cash availability time series for the first entity. For one or more data points of the cash availability time series for the last two years, the system 100 categorizes the first entity as “at serious risk,” “in distress,” or “normal.” For example, for a single data point, the system 100 determines if the financial account is closed or if expenses exceed income over the N days preceding the single data point (such as 90 days for N equals 90). Any of the data points may be selected for categorizing the entity. In some implementations, the system 100 randomly selects data points for which to categorize the entity. In some other implementations, the system 100 categorizes the entity periodically over the historic time series data (e.g., for an interval of data points, such as every other data point, every third data point, or even every data point).

The historic time series data (such as the previous cash availability time series) as an input to the RNN 140 and the associated categorizations as a desired prediction from the RNN 140 are tuples of input and desired output for which to train the RNN 140 via supervised learning. In addition to the previous cash availability time series as an input to the RNN 140, time series data for one or more other features may also be an input to the RNN 140. As noted above, one or more features may include entity specific features (such as business revenue, expenses, etc.) or features associated with multiple entities (such as an industry specific feature or a location specific feature for a plurality of businesses).

At 506, the system 100 obtains prior time series data for each of one or more features associated with the one or more entities. If the one or more entities is a plurality of entities, the prior time series data of the one or more features may be obtained for each of the plurality of entities. As noted above, time series data of one or more features may be obtained from any suitable source, such as directly from the entity or from a publicly available source. If the one or more entities includes the first entity, the prior time series data may have been collected over time by the system 100 and stored on the system 100 (such as by the database 120 or the memory 135). Alternatively, the prior time series data may be collected by the user and provided by the user to the system 100.

At 508, the system 100 uses the determined prior cash statuses, the prior cash availability time series, and the prior time series data for each of the one or more features associated with the one or more entities to train the RNN 140 to generate a prediction for the first entity. The prior cash availability time series and the prior time series data for one or more features are inputs to the RNN 140, and the determined prior cash statuses are the desired outputs from the RNN 140. For example, if the RNN 140 is the LSTM network 200 and N equals 90 for time series including daily data points, 90 days of data points immediately preceding a daily data point corresponding to a determined cash status may be provided to the LSTM network 200 (such as described above with reference to FIGS. 2 and 3). The predictor 208 generates a predicted cash status of the entity based on the input. The system 100 then compares the predicted cash status and the determined cash status. The comparison may be provided as feedback in adjusting the LSTM network 200. The process of generating a prediction, comparing the desired prediction and the generated prediction, and providing the comparison as feedback to adjust LSTM network 200 may be repeated until the LSTM network 200 is trained. For example, an error may be determined based on the generated predictions from the LSTM network 200 and the desired predictions. Training the LSTM network 200 may continue until the error is below an error threshold. In some implementations, the Adam algorithm may be used to train the RNN 140 (such as the LSTM network 200). However, any suitable optimization or training algorithm may be used to train the RNN 140.

In some implementations, the RNN 140 may be periodically trained while deployed or otherwise in use. For example, the system 100 may retrain the RNN 140 every month. In another example, prior predictions may be compared to actual results once the financial information is available in the future. If the accuracy of the prior predictions (such as the last 30 predictions) is less than an accuracy threshold, the system 100 may retrain the RNN 140. In a further example, a moderator or user may request that the RNN 140 be retrained. In this manner, the RNN 140 may stay relevant over time in predicting the equity status of the first entity.

As described above, a trained RNN 140 is configured to predict an equity status (such as a cash status) of a first entity for some time in the future, and the prediction may be indicated to a user. In some implementations, the system 100 is also configured to determine one or more actions that can be taken to prevent a prediction from coming true for the first entity. As noted above, time series data for one or more features associated with the first entity are provided as input to the RNN 140. Adjusting the time series data for at least one of the features may cause the RNN 140 to generate a different prediction for the first entity (such as categorizing the first entity as “normal” instead of “in distress”).

In some implementations, the system 100 predicts (by the RNN 140) that the first entity is to be at serious risk or is to be in distress. In response to predicting that the first entity is to be at serious risk or is to be in distress, the system 100 may adjust at least one time series data for the one or more features associated with the first entity to cause the RNN 140 to predict that the first entity is normal. Such adjustments to the time series data may be used to determine one or more actions to be taken to prevent the first entity from being in serious risk or in distress. For example, if one or more data points of a daily expenses time series are slightly adjusted, one or more actions to reduce daily expenses may be determined to cause such adjustments in the time series data (such as reducing electricity costs (including reducing the number of lights, increasing the temperature in the store, reducing the number of freezers in a grocery store, and so on), reducing business tool costs (such as requesting discounts or rebates from one or more service providers, switching to free or cheaper productivity tools, and so on), adjusting inventory to carry higher margin products, etc.). To note, the system 100 may adjust the data points of time series data for only features that can be controlled for the entity. For example, data points for a fixed cost feature may not be adjusted since there is no control over such fixed costs (e.g., a fixed mortgage payment, required easement payment, etc.).

The system 100 may include a list of predefined actions associated with each feature that may be adjusted. For example, expense related features may be associated with one or more predefined actions to reduce costs (such as how to reduce electricity costs, store stock costs, etc.). In another example, income related features may be associated with one or more predefined actions to increase income (such as increasing store hours, carrying certain higher margin products, etc.). In a further example, employment features may be associated with one or more predefined actions (such as approving overtime, preventing overtime, increasing the number of employees, etc.). The list of predefined actions may also differentiate between different types of predictions. For example, more drastic actions may be associated with a prediction of an entity being at serious risk, and less drastic actions may be associated with a prediction of an entity being in distress. The actions may be determined by an expert or predefined by a user.

The list of predefined actions may be stored on the system 100. For example, the database 120 may store the predefined actions for each associated feature. In this manner, if the system 100 adjusts the feature's time series data to cause the RNN 140 to predict that the first entity is normal, the system 100 may determine one or more actions to take by obtaining the predefined actions from the database 120 for the feature. While an example of determining the one or more actions is provided above, any suitable means of determining one or more actions may be used. The system 100 may thus provide an indication of one or more actions to be taken to prevent the first entity from being in serious risk or in distress based on the adjustment to at least one time series data for the one or more features, and the one or more actions may be indicated to the user. If the system 100 is local to the user, the system 100 may indicate the one or more actions via a display. If the system 100 is remote to the user, the system 100 may provide an indication of the one or more actions via the interface 110 and through the internet to a user system (with the user system indicating the one or more actions to the user).

Which time series and specific data points to adjust (for features which the time series data is allowed to be adjusted) may be determined in any suitable manner. For example, the system 100 may store a prioritized list of features for adjustment. In this manner, a first feature on the list may have its time series data first adjusted. A specific example of adjusting the time series data to cause the RNN 140 to generate a different prediction is described below with reference to FIG. 6.

FIG. 6 shows an illustrative flow chart depicting an example operation 600 for determining one or more actions to be taken to prevent a prediction from the system 100 (such as an entity from being in serious risk or in distress), according to some implementations. In some implementations, example operation 600 is performed after the system 100 predicts that an entity is to be at serious risk or is to be in distress. At 602, the system 100 selects a first feature for which the time series data is to be adjusted. For example, the system 100 may store a prioritized list of features for adjustment. The list may be generated beforehand by a moderator or expert based on previous experience in which features most impact the predictions and/or which features are easiest to control for the entity. Alternatively or additionally, the list may be generated or amended by a user based on the user's wishes or specific knowledge regarding the entity. Selecting a first feature may include the system 100 selecting the first feature on the list. In some other implementations, the system 100 may select a feature randomly, may select a feature based on a variance of the data points of the time series data for the feature (such as selecting a feature if the time series data includes large swings in the data points), or may select the feature in any other suitable manner.

At 604, after the first feature is selected, the system 100 adjusts the time series data for the first feature. Adjusting the time series data may be in any suitable manner. In some implementations, the system 100 adjusts the time series data by a defined amount (such as increasing or decreasing each data point by an x amount, or increasing or decreasing each data point by y percent). In some other implementations, the system 100 adjusts outliers of the time series data. For example, if a data point is above a threshold (such as more than two standard deviations away from the mean of the time series data, above defined threshold z, etc.), the data point may be replaced with a mean value, moved towards the mean, or removed from the time series data. If the data point is removed from the time series data, the LSTM unit of the LSTM network 200 to receive the data point may output the input from the previous LSTM layer. Any number of data points may be adjusted during step 604. For example, the system 100 may adjust one data point (which may be the most recent data point, the largest outlier, the first data point, a randomly selected data point, or any other data point). In another example, the system 100 may adjust a threshold number of data points or a plurality of data points that meet a certain criteria (such as data points being greater than a specific threshold).

At 606, the system 100 generates a prediction by the RNN 140 using the adjusted time series data for the selected feature. In this manner, the time series data for the one or more features is provided to the RNN 140 (with the adjusted time series data for the selected feature replacing the original time series data for the selected feature), and the RNN 140 generates a prediction. If a desired prediction is generated (608), the system 100 determines one or more actions based on the selected feature (610). For example, the system 100 may determine that the new prediction is that the entity is to be normal (instead of “in distress” or “at serious risk”) based on the adjusted input to the RNN 140. The system 100 predicting that the entity is to be normal would be based on the changes to the selected feature time series data. The system 100 may determine one or more actions by obtaining one or more actions predefined for the selected feature (such as described above). As noted above, the list of predefined actions may differentiate between different types of predictions (such as between categories “at serious risk” and “in distress”). In some implementations, the system 100 may determine the one or more actions from the list based on the original prediction by the RNN 140. However, any suitable manner in determining one or more actions may be used.

Referring back to decision block 608, if a desired prediction is not generated (such as the new prediction being the same as the original prediction), the system 100 may determine if further adjustments are to be made to the time series data for the selected feature (612). For example, if one data point is to be adjusted at a time, the system 100 may determine if the same data point is to be further adjusted or if a next data point exists for adjustment. In another example, if all data points are adjusted by a first defined amount, the system 100 may determine if the data points are to be adjusted again by a second defined amount. In a further example, if a first group of outliers are adjusted, the system 100 may determine if a second group of outliers are to be adjusted (such as data points lying more than two standard deviations away from the mean of the data points of the time series being adjusted during a first pass through step 604 and data points lying more than one standard deviation away from the mean being adjusting during a second pass through step 604. If further adjustments are to be made to the time series data for the selected feature (612), the process reverts to step 604, with the system 100 adjusting one or more data points of the time series data for the selected feature.

Referring back to decision block 612, if further adjustments are not to be made (such as previously adjusted data points not to be further adjusted and no additional data points exist or are to be adjusted), the system 100 determines if another feature is to be selected (614). For example, if the system 100 stores a prioritized list of features for adjustment, the system 100 determines if another feature is on the list after the currently selected feature. If no other feature is to be selected (614), the process ends. If another feature is to be selected (614), the system 100 selects a next feature for which the time series data is to be adjusted (616). The process then reverts to step 604, with the system 100 adjusting the time series data for the newly selected feature. In some implementations, when reverting back to step 604 for a newly selected feature, the previously selected feature's time series data may be reverted back to the original time series data (removing the adjustments made for the feature). In some other implementations, the time series data may remain adjusted for the previously selected feature.

Referring back to step 610, while the example operation 600 is depicted as ending after determining one or more actions for one feature, the example operation 600 may be repeated or may continue after step 610. For example, if an additional feature exists on the list (decision block 614), the process may continue to step 616. In this manner, the system 100 may determine more than one feature whose time series data may be adjusted to cause the RNN 140 to generate a desired prediction. The system 100 may thus determine one or more actions for each of the features.

While FIG. 6 depicts only one feature's time series data being adjusted at one time, time series data for more than one feature may be adjusted at one time. For example, if no other feature is to be selected at decision block 614, the system 100 may select two features. The system 100 may then go through the different combinations of two features, three features, and so on until all possible combinations of features are selected. In some implementations, the prioritized list of features stored by the system 100 may indicate one or more combinations of multiple features. While some examples for adjusting the time series data are provided, other implementations for adjusting the one or more time series may be performed, such as use of a brute force algorithm or a genetic algorithm. With the one or more actions determined, the system 100 provides an indication of the one or more actions (such as to the user via a display or to a user's system via the interface 110 and the internet for the user's system to indicate the one or more actions to the user).

As described above, a system is configured to predict an equity status of an entity to indicate the financial health of the entity (such as a cash status of a small business some time into the future). In some implementations, the system is also configured to determine one or more actions to be performed to prevent a prediction from coming true. As noted above, the system provides an indication of the prediction and an indication of the one or more actions. The system may be configured to determine the prediction and/or the one or more actions on demand, periodically based on a schedule (such as every day or night, every week, for each transaction, etc.), or in any other suitable manner. In some implementations, if the system generates a prediction of an entity being at serious risk or in distress, the frequency at which predictions and/or actions are determined may be increased (such as from once a week to once a day).

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c, and “one or more of: a, b, or c” is intended to cover: a, b, c, a-b, a-c, b-c, and a-b-c.

The various illustrative logics, logical blocks, modules, circuits, and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices such as, for example, a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. For example, while an RNN is described in the examples above, a system may include any suitable sequential artificial intelligence (AI) model, such as a model built using BrewAl. In another example, while the figures and description depict an order of operations to be performed in performing aspects of the present disclosure, one or more operations may be performed in any order or concurrently to perform the described aspects of the disclosure. In addition, or to the alternative, a depicted operation may be split into multiple operations, or multiple operations that are depicted may be combined into a single operation. Thus, the claims are not intended to be limited to the implementations shown herein but are to be accorded the widest scope consistent with this disclosure, the principles, and the novel features disclosed herein.

What is claimed is:

1. A computer-implemented method for predicting a future equity status of an entity, comprising:
obtaining a first time series data associated with a first entity;
predicting, by a recurrent neural network, a future equity status of the first entity based on the first time series data; and
providing an indication of the future equity status of the first entity, wherein the future equity status of the first entity is to be indicated to a user.

2. The method of claim 1, wherein the recurrent neural network includes a long short-term memory (LSTM) network.

3. The method of claim 1, further comprising:
obtaining time series data for each of one or more features associated with the first entity; and
providing the time series data for the one or more features to the recurrent neural network, wherein predicting the future equity status of the first entity is based on the time series data for the one or more features.

4. The method of claim 3, wherein the one or more features include:
at least one feature specific to the first entity; and
at least one feature associated with multiple entities including the first entity.

5. The method of claim 3, wherein:
the future equity status of the first entity includes a future cash status of the first entity; and
the first time series data includes a cash availability time series indicating a cash availability to the first entity over a time period.

6. The method of claim 5, wherein the recurrent neural network is trained by performing operations including:
for each entity of one or more entities:
obtaining a prior cash availability time series indicating a cash availability to the entity over a previous time period; and
determining a prior cash status of the entity for one or more points of the prior cash availability time series;
obtaining prior time series data for each of the one or more features associated with the one or more entities; and
using the determined prior cash statuses, prior cash availability time series, and the prior time series data for each of the one or more features associated with the one or more entities to train the recurrent neural network to generate a prediction for the first entity.

7. The method of claim 6, wherein the future cash status of the first entity is one of:
the first entity is predicted to be at serious risk;
the first entity is predicted to be in distress; or
the first entity is predicted to be normal.

8. The method of claim 7, wherein determining the prior cash status of an entity of the one or more entities includes:
determining that the entity is at serious risk when a financial account for which the prior cash availability time series is associated is closed;
determining that the entity is in distress when the entity has more expenses than income from the financial account for a predefined period preceding a point of the prior cash availability time series; and
determining that the entity is normal when the financial account remains open and the entity does not have more expenses than income from the financial account for the predefined period preceding the point of the prior cash availability time series.

9. The method of claim 7, further comprising:
predicting, by the recurrent neural network, that the first entity is to be at serious risk or is to be in distress;
in response to predicting that the first entity is to be at serious risk or is to be in distress, adjusting at least one time series data for the one or more features associated with the first entity to cause the recurrent neural network to predict that the first entity is normal; and
providing an indication of one or more actions to be taken to prevent the first entity from being in serious risk or in distress based on the adjustment to the at least one time series data for the one or more features, wherein the one or more actions are to be indicated to the user.

10. The method of claim 1, wherein obtaining the first time series data associated with the first entity includes receiving financial records from a financial institution for a linked financial account.

11. A system for predicting a future equity status of an entity, comprising:
one or more processors; and
a memory storing instructions that, when executed by the one or more processors, causes the system to perform operations comprising:
obtaining a first time series data associated with a first entity;
predicting, by a recurrent neural network, a future equity status of the first entity based on the first time series data; and
providing an indication of the future equity status of the first entity, wherein the future equity status of the first entity is to be indicated to a user.

12. The system of claim 11, wherein the recurrent neural network includes a long short-term memory (LSTM) network.

13. The system of claim 11, wherein the operations further comprise:
obtaining time series data for each of one or more features associated with the first entity; and
providing the time series data for the one or more features to the recurrent neural network, wherein predicting the future equity status of the first entity is based on the time series data for the one or more features.

14. The system of claim 13, wherein the one or more features include:
at least one feature specific to the first entity; and
at least one feature associated with multiple entities including the first entity.

15. The system of claim 13, wherein:
the future equity status of the first entity includes a future cash status of the first entity; and
the first time series data includes a cash availability time series indicating a cash availability to the first entity over a time period.

16. The system of claim 15, wherein the recurrent neural network is trained by performing operations including:
for each entity of one or more entities:
obtaining a prior cash availability time series indicating a cash availability to the entity over a previous time period; and
determining a prior cash status of the entity for one or more points of the prior cash availability time series;
obtaining prior time series data for each of the one or more features associated with the one or more entities; and
using the determined prior cash statuses, the prior cash availability time series, and the prior time series data for each of the one or more features associated with the one or more entities to train the recurrent neural network to generate a prediction for the first entity.

17. The system of claim 16, wherein the future cash status of the first entity is one of:
the first entity is predicted to be at serious risk;
the first entity is predicted to be in distress; or
the first entity is predicted to be normal.

18. The system of claim 17, wherein determining the prior cash status of an entity of the one or more entities includes:
determining that the entity is at serious risk when a financial account for which the prior cash availability time series is associated is closed;
determining that the entity is in distress when the entity has more expenses than income from the financial account for a predefined period preceding a point of the prior cash availability time series; and
determining that the entity is normal when the financial account remains open and the entity does not have more expenses than income from the financial account for the predefined period preceding the point of the prior cash availability time series.

19. The system of claim 17, wherein the operations further comprise:
predicting, by the recurrent neural network, that the first entity is to be at serious risk or is to be in distress;
in response to predicting that the first entity is to be at serious risk or is to be in distress, adjusting at least one time series data for the one or more features associated with the first entity to cause the recurrent neural network to predict that the first entity is normal; and
providing an indication of one or more actions to be taken to prevent the first entity from being in serious risk or in distress based on the adjustment to the at least one time series data for the one or more features, wherein the one or more actions are to be indicated to the user.

20. The system of claim 11, wherein obtaining the first time series data associated with the first entity includes receiving financial records from a financial institution for a linked financial account.
